(19) United States
(12) Patent Application Publication
(10) Pub. No.: US 2023/0166904 A1
(43) Pub. Date: Jun. 1, 2023

(54) Recycling Bin Foot

(71) Applicant: Anaahad Kaur, Kitchener (CA)

(72) Inventor: Anaahad Kaur, Kitchener (CA)

(21) Appl. No.: 17/536,023

(22) Filed: Nov. 27, 2021

(51) Int. Cl. B65F 1/14; B65D 21/02

(52) U.S. Cl. CPC B65F 1/141; B65D 21/0215

(57) ABSTRACT

A device to help prevent recycling bins from falling over due to strong winds. The device broadens the base of the recycling bins and adds friction to the bottom of the recycling bin to make it harder to move. The device also provides a handle and a stacking feature to store the recycling bins.

### BACKGROUND

In windy weather conditions, recycling bins often tip over due to strong winds. Due to these conditions, waste from the bins tends to go onto streets as well as sidewalks and lawns, which can be an inconvenience as well as a hazard. There is a need for a cost effective and an easy-to-use solution to this problem.

### SUMMARY

The device when attached to a recycling bin, provides the bin with a wider base, making it less susceptible to toppling. There are several aspects to the design of the device, and they are an open right-angle structure, a closed triangular feature with an outside slant, an opening that forms a handle and a cross-rib structure at the bottom of the device. To commence, the open right-angle structure is designed to allow users to assemble this device with ease. The open right-angle structure allows the device to be attached to the recycling bin using double sided tape or other fastening means. The outside slant on the closed triangular feature connects the vertical wall and the bottom face, which provides strength to the device and forms a triangular feature on the backside of the open right-angle feature in the device that can be used as a grip or a handle. Finally, the cross-rib structure is located at the bottom of the device. This feature is composed of extruded rectangular shapes and is designed to dig into the ground and to provide friction to prevent movement of the recycling bin when pushed sideways.

### DESCRIPTION OF THE FIGURES

In the figures,

FIG. 1 shows a top isometric view of an assembly where multiple devices, the feet, are attached to a recycling bin.

FIG. 2 shows a bottom isometric view of an assembly where multiple devices, the feet, are attached to a recycling bin.

FIG. 3 shows a side view of the device, the foot.

FIG. 4 shows a bottom isometric view of the device, the foot.

FIG. 5 shows a top isometric view of the device, the foot.

FIG. 6 shows a bottom isometric view of a recycling bin and device assembly.

FIG. 7 shows a top isometric view of two assemblies in stacked manner.

FIG. 8 shows a bottom isometric view of two assemblies in stacked manner.

FIG. 9 shows a bottom isometric view of an assembly showing an alternate design of the device.

FIG. 10 shows a top isometric view of two assemblies with an alternate design of the device in stacked manner.

### DETAIL DESCRIPTION

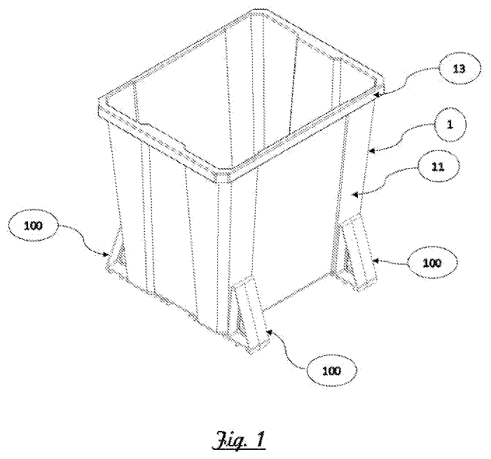

As shown in FIG. 1 four devices, 100, are attached to a recycling bin 1. Each device 100 can be attached to the recycling bin 1 using various fastening means, such as double side tape, screws and others. Each device 100 is attached to the long vertical side wall 11 of the recycling bin 1 to provide stability to the recycling bin. The devices 100 are placed on the ends of the vertical side wall 11 of the recycling bin 1. Recycling bin 1 has a rim 13 on top.

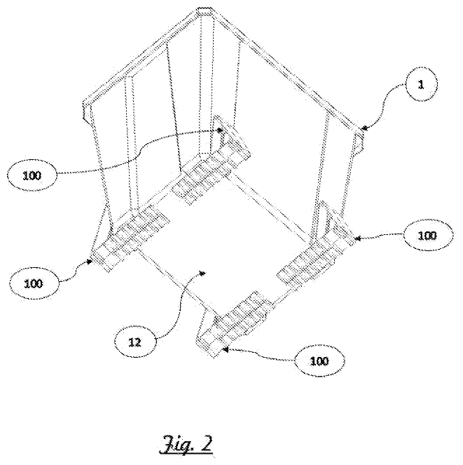

As shown in FIG. 2 four devices 100 are also attached to the bottom face 12 of the recycling bin 1.

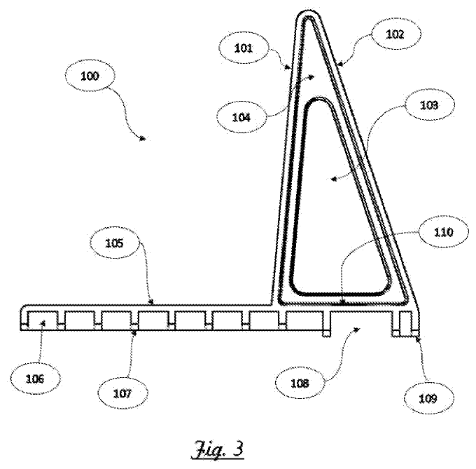

FIG. 3 shows the shape and features of the device 100 from its side view. Device 100 has a flat horizontal face 105 which joins to a vertical face 101 forming an right angle between them. Vertical face 101 further joins an inclined face 102 to form an acute angle between them. Inclined face 102 further joins another horizontal face 110 forming an acute angle between them. Face 101, 102 and 110 forms a closed triangular feature, the triangular feature provides strength to the device 100. Inside of the triangular feature there is a wall 104 with an opening 103 to provide further strength to the device 100. Vertical face 101 abuts vertical side wall 11 of the recycling bin 1 and horizontal face 105 abuts bottom face 12 of the recycling bin 1 when they are assembled. On the opposite side of horizontal face 105 there are vertical cross ribs 106 and 107; these ribs are meant to contact the resting surface of the recycling bin and device assembly. A notch 108 under the horizontal face 110 is designed to accommodate rim 13 of the recycling bin 1. Cross rib structure 109 under the horizontal face 110 is there to surround the notch 108.

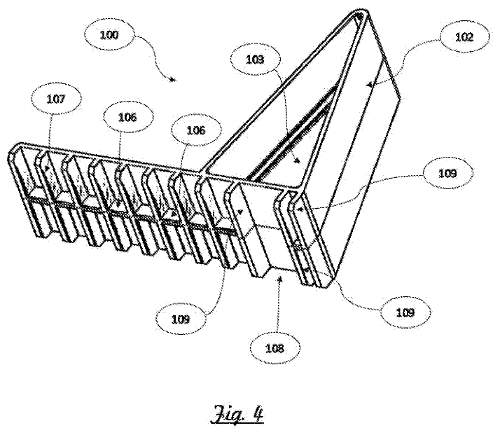

FIG. 4 shows a bottom view of the device 100. This view clearly shows the bottom cross ribs 106, 107 and 109. Ribs 106 runs along the length of horizontal face 105 whereas the ribs 107 and 109 run in the width direction of the horizontal face 105 and 110 respectively. The cross-rib structure formed by 106, 107 and 109 ribs help the device grip to various resting surface conditions like grassed lawn, snow, dirt and so on.

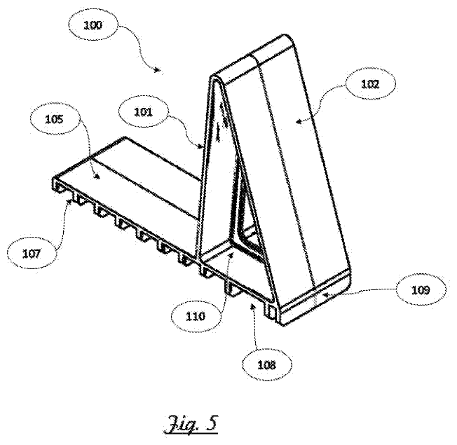

FIG. 5 shows the device 100 from top view. This figure clearly shows the triangular structure formed by faces 101, 102 and 110. This structure is designed to provide strength to the device 100 when any sideways force acts on the assembly of recycling bin 1 and device 100.

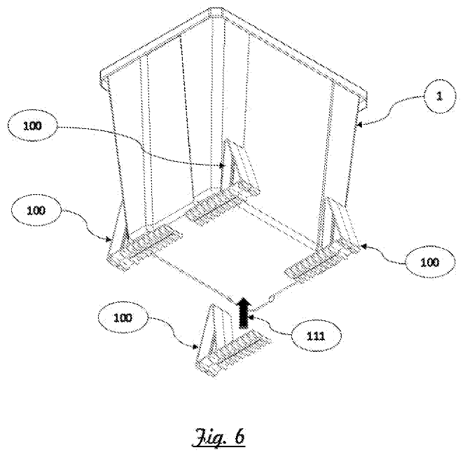

FIG. 6 gives an overview of an assembly. The figure shows three of the four devices 100 already attached to recycling bin 1, the fourth device 100 can be attached to the recycling bin 1 by moving it towards the recycling bin in the direction pointed by arrow 111. Attachment of the device 100 to the recycling bin 1 can be achieved by using various fastening methods like double side tape (not shown).

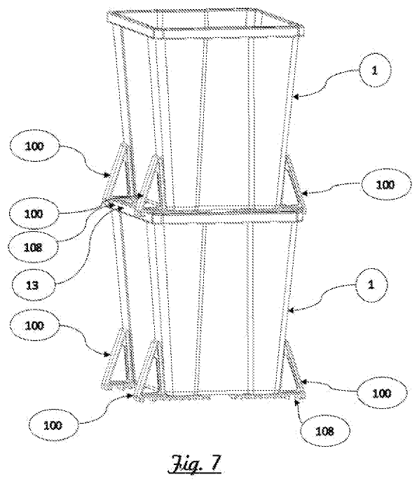

FIG. 7 shows one assembly of recycling bin 1 and four devices 100 stacked above another similar assembly. The notch 108 of the devices 100 in top assembly capture the rim 13 of recycle bin 1 of the bottom assembly, which makes the assemblies stack over one another securely. All four devices of the top assembly capture the rim 13 of bottom assembly recycling bin 1.

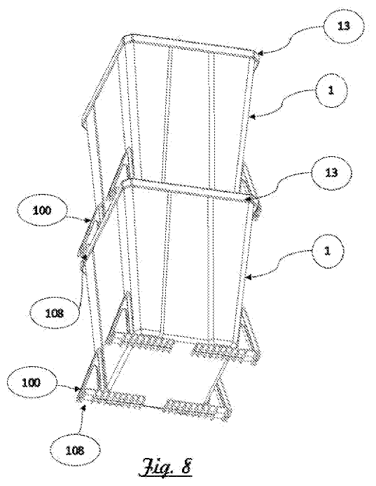

FIG. 8 shows the bottom isometric view of the stacked assemblies. The view shows capturing of the rim 13 of the bottom assembly by the notch 108 of devices 100 of the top assembly.

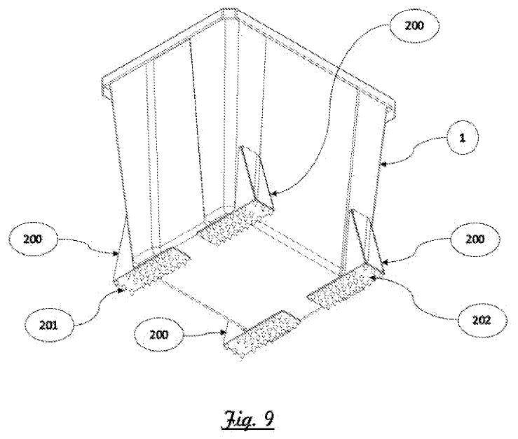

FIG. 9 shows an assembly of recycling bin 1 with an alternate design of device 100 called 200. In this alternate design of the device the cross ribs structure at the bottom of the device is replaced by spikes 201 and the notch 108 is replaced by an enlarged gap 202 between the spikes.

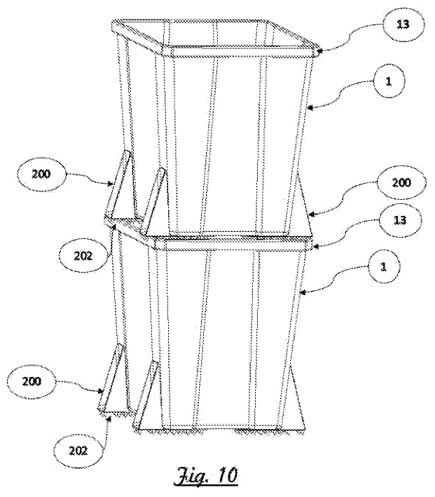

FIG. 10 shows stacking of assemblies with device 200. The view shows capturing of the rim 13 of the bottom assembly by the gap 202 between the spikes 201 of the top assembly.

What is claimed is:

1. A recycling bin foot comprising:
two faces forming an open right-angle structure,
a closed geometrical shape formed at distal end of the said open right-angle structure, and
a notch feature formed under the said closed geometrical shape.

2. The recycling bin foot of claim 1, where in the open right-angle structure has a horizontal face and a vertical face.

3. The recycling bin foot of claim 1, where in the closed geometrical shape is formed at the back side of the open right-angle structure.

4. The recycling bin foot of claim 2, where in the horizontal face of the open right-angle structure is parallel to bottom face of the closed geometrical shape.

5. The recycling bin foot of claim 2, where in the vertical face of the open right-angle structure and vertical face of the closed geometrical shape are common faces.

6. The recycling bin foot of claim 2, where in the horizontal face has projections on opposite side of the vertical face.

7. The recycling bin foot of claim 4, where in distal end of the bottom face of the closed geometrical shape has a projection on opposite side of the vertical face.

8. The recycling bin foot of claim 6 and claim 7, where in a gap is created between the projections under the horizontal face of the right-angle structure and projection under the bottom face of the closed geometrical shape.

9. The recycling bin foot of claim 8, where in the gap forms a notch feature under the closed geometrical shape.

10. The recycling bin foot of claim 1, where in the closed geometrical shape is a triangle.

11. A method of attaching a recycling bin foot to a recycling bin, where in a recycling bin foot comprising:
two faces forming an open right-angle structure,
a closed geometrical shape formed at the distal end of the said open right-angle structure, and
a notch feature formed under the said closed geometrical shape.

12. The method of attaching the recycling bin foot to a recycling bin of claim 10, where in the open right-angle structure has a horizontal face and a vertical face.

13. The method of attaching the recycling bin foot to a recycling bin of claim 11, where in the horizontal face of the open right-angle structure is designed to abut against bottom face of a recycling bin and the vertical face of the right-angle structure abut against side wall of the recycling bin.

14. The method of attaching the recycling bin foot to a recycling bin of claim 12, where in the horizontal face permanently attaches to the bottom face of the recycling bin by means of a double side tape placed between the horizontal face and the bottom face of the recycling bin.

15. The method of attaching the recycling bin foot to a recycling bin of claim 12, where in the vertical face permanently attaches to the side wall of the recycling bin by means of a double side tape placed between the vertical face and the side wall of the recycling bin.

16. The method of attaching the recycling bin foot to a recycling bin of claim 14, where in at least one recycling bin foot is attached to a recycling bin.
